(19) United States
(12) Patent Application Publication
(10) Pub. No.: US 2008/0088744 A1
(43) Pub. Date: Apr. 17, 2008

(54) APPARATUS FOR PROVIDING MULTIPLE SCREENS AND METHOD OF DYNAMICALLY CONFIGURING MULTIPLE SCREENS

(75) Inventors: Jong-ho LEE, Seoul (KR); Kwang-kee LEE, Seoul (KR); Sung-wook BYUN, Suwon-si (KR); Glenn A. ADAMS, Acton, MA (US); Un-gyo JUNG, Hwaseong-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/957,739

(22) Filed: Dec. 17, 2007

Related U.S. Application Data
(63) Continuation-in-part of application No. 11/496,403, filed on Aug. 1, 2006.
(60) Provisional application No. 60/705,491, filed on Aug. 5, 2005.
(60) Provisional application No. 60/789,577, filed on Apr. 6, 2006.
(60) Provisional application No. 60/812,090, filed on Jun. 9, 2006.
(60) Provisional application No. 60/870,471, filed on Dec. 18, 2006.
(60) Provisional application No. 60/918,894, filed on Mar. 20, 2007.

(30) Foreign Application Priority Data
Feb. 26, 2007 (KR) 10-2007-0019236

(51) Int. Cl. H04N 9/74

(52) U.S. Cl. 348/588; 348/E09.055

(57) ABSTRACT

Provided are an apparatus for providing multiple screens and a method of dynamically configuring multiple screens in which a plurality of screens for providing a plurality of content items are dynamically configured using flags included in received packets. The apparatus includes a digital signal processing module which determines whether an application included in received data information supports a plurality of logical screens for representing a plurality of services based on a signal included in the received data information, and an operational module which maps the plurality of logical screens to a display screen according to a result of the determination performed by the digital signal processing module.

### CROSS-REFERENCES TO RELATED APPLICATIONS

This application is a continuation-in part of U.S. patent application Ser. No. 11/496,403 filed on Aug. 1, 2006, which claims priority from U.S. Provisional Patent Application No. 60/705,491 filed on Aug. 5, 2005, U.S. Provisional Patent Application No. 60/789,577 filed on Apr. 6, 2006, and U.S. Provisional Patent Application No. 60/812,090 filed on Jun. 9, 2006, the disclosures of which are incorporated herein by reference in their entirety. This application also claims priority from U.S. Provisional Patent Application No. 60/870,471 filed on Dec. 18, 2006, U.S. Provisional Patent Application No. 60/918,894 filed on Mar. 20, 2007, and Korean Patent Application No. 2007-0019236 filed on Feb. 26, 2007, the disclosure of which are incorporated herein by reference in their entirety.

### BACKGROUND OF THE INVENTION

1. Field of the Invention

Apparatuses and methods consistent with the present invention relate to providing and dynamically configuring multiple screens, and more particularly, to dynamically configuring multiple screens for providing a plurality of content items using flags included in received packets.

2. Description of the Related Art

Related art broadcast receivers such as digital televisions (TVs) or digital set-top boxes provide only one content element on a single physical display device or simultaneously display a main screen and a sub-screen on a single physical display device.

Even though related art broadcast receivers can simultaneously display both the main screen and the sub-screen on the same display screen, they can only arrange the main screen and the sub-screen in a limited number of manners. In the case of a content item displayed within the main screen, all elements of the content item, i.e., video data, audio data, and other data, are displayed. On the other hand, in the case of a content item displayed within the sub-screen, only some of the elements of the content item are displayed.

Content sources include a broadcast service such as a satellite broadcaster, a terrestrial broadcaster, or a cable broadcaster, a storage medium such as digital versatile discs (DVDs), or an external device connected to an input terminal. However, it is quite difficult to display content items provided by such various content sources on a display screen using the existing broadcast receivers.

In an interactive TV application program environment such as the Multimedia Home Platform (MHP), the Advanced Common Application (ACAP), and the Open Cable Application Platform (OCAP), it is assumed that only one screen is output on a physical display device.

In the interactive TV application program environment, for example, a Home Audio/Video Interoperability (HAVi)-based user interface (UI) is adopted. According to the HAVi UI standard, even though no restriction is imposed on the number of screens displayed on a physical display device, only one screen is generally displayed on a physical display device.

In such an environment, it is difficult to perform operations, such as decoding, digital signal processing, user interaction processing, etc. with respect to one among multimedia content items displayed on a screen while displaying the multimedia content items on independent screens. In addition, it is also difficult to dynamically control the life cycles of application programs and the use of resources in the units of the screens.

Accordingly, there exists a need for a method of displaying a variety of content items on a dynamically configured screen.

### SUMMARY OF THE INVENTION

The present invention provides an apparatus for providing multiple screens and a method of dynamically configuring multiple screens in which a plurality of screens for providing a plurality of content items are dynamically configured using flags included in received packets.

According to an aspect of the present invention, there is provided an apparatus for providing multiple screens. The apparatus includes a digital signal processing module which determines whether an application included in received data information supports a plurality of logical screens for representing a plurality of services based on a signal included in the received data information, and an operational module which maps the logical screens to a display screen according to the result of the determination performed by the digital signal processing module.

According to another aspect of the present invention, there is provided a method of dynamically configuring multiple screens. The method includes determining whether an application included in received data information supports a plurality of logical screens for representing a plurality of services based on a signal included in the received data information, and mapping the logical screens to a display screen according to the result of the determination.

### BRIEF DESCRIPTION OF THE DRAWINGS

The above and other aspects of the present invention will become more apparent by describing in detail exemplary embodiments thereof with reference to the attached drawings in which:

FIG. 1A to 1H are diagrams illustrating configurations of a PiP screen according to exemplary embodiment of the present invention;

FIG. 2 is a diagram illustrating the relationship between a logical screen and a display screen according to an exemplary embodiment of the present invention;

FIG. 3 is a block diagram illustrating service sources according to an exemplary embodiment of the present invention;

FIGS. 4A and 4B are diagrams illustrating a non-abstract service and an abstract service according to an exemplary embodiment of the present invention;

FIG. 5 is a diagram illustrating a method of mapping two services to a display screen according to an exemplary embodiment of the present invention;

FIG. 6 is a diagram illustrating a configuration of a system for providing multiple screens according to an exemplary embodiment of the present invention;

FIG. 7 is a block diagram illustrating a configuration of an apparatus for providing multiple screens according to an exemplary embodiment of the present invention;

FIG. 8 is a flowchart illustrating a method of dynamically configuring multiple screens according to an exemplary embodiment of the present invention.

### DETAILED DESCRIPTION OF EXEMPLARY EMBODIMENTS OF THE INVENTION

Advantages and features of the present invention and methods of accomplishing the same may be understood more readily by reference to the following detailed description of exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

The present invention is described hereinafter with reference to flowchart illustrations of user interfaces, methods, and computer program products according to exemplary embodiments of the invention. It will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which are executed via the processor of the computer or other programmable data processing apparatus, create means for implementing the functions specified in the flowchart block or blocks.

These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Each block of the flowchart illustrations may represent a module, segment, or portion of code, which comprises one or more executable instructions for implementing the specified logical function(s). It should also be noted that in some alternative implementations, the functions noted in the blocks may occur out of the order. For example, two blocks illustrated in succession may in fact be executed substantially concurrently or the blocks may sometimes be executed in the reverse order, depending upon the functionality involved.

For a better understanding of the present invention, the terms used in this disclosure will now be defined.

The term ‘service’ indicates a group of multimedia content items displayed together, i.e., a group of service components.

Service components are elements of a service and include a video component, an audio component, and a data component. A data component is an application program in a service.

The term ‘service context’ indicates an object which can control the executing of a service and includes various resources information, device information, and execution state information needed for providing a service.

The term ‘physical display device’ indicates a physical space which actually displays the content of a service.

The term ‘display screen’ indicates a screen actually displayed on a physical display device. An arbitrary service may be directly set in the display screen, and the display screen may be displayed on a physical display device. Alternatively, at least one logical screen which is mapped to a certain area of the display screen may be displayed on the physical display device.

The term ‘logical screen’ indicates a space in which an arbitrary service is displayed. A logical screen is a virtual screen before being mapped to a display screen and thus is not displayed on a physical display device.

The logical screen and the display screen may be a combination of a background still image, a video raster, and a graphic raster. The graphic raster may be a combination of text, lines, colors, and images or a mixture of video frames.

The term ‘main service’ indicates a service that is selected as a main service through a menu displayed on the physical display device or a remote controller by a user or through an API by an application, and the screen on which the main service is displayed is referred to as a ‘main screen’.

The term ‘Picture-in-Picture service’ (PiP service) indicates a service that is selected as a sub-service in the main service through a menu displayed on a physical display device or a remote controller by a user or via an API by an application, and the PiP service may be displayed on a picture-in-picture screen (PiP screen) or a main screen.

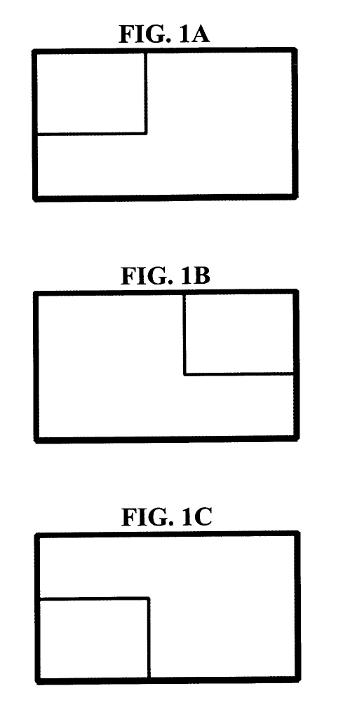

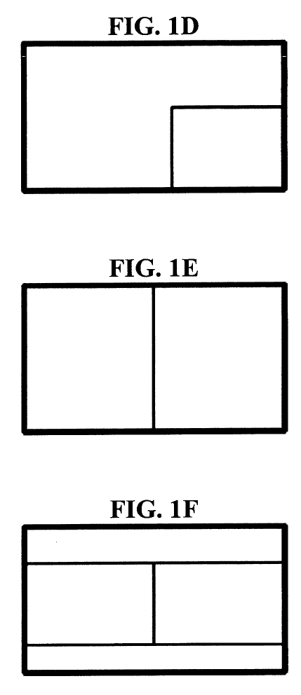

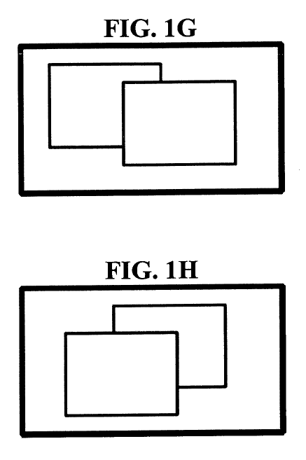

The PiP screen includes a screen that occupies a part of another screen as illustrated in FIGS. 1A to 1D and a screen that is simultaneously displayed with another screen without overlapping the other screen as illustrated in FIGS. 1E to 1F. In this case, it is understood that the PiP screen may include a screen that overlaps another screen on an arbitrary location or area in the physical display device, as illustrated in FIGS. 1G and 1H.

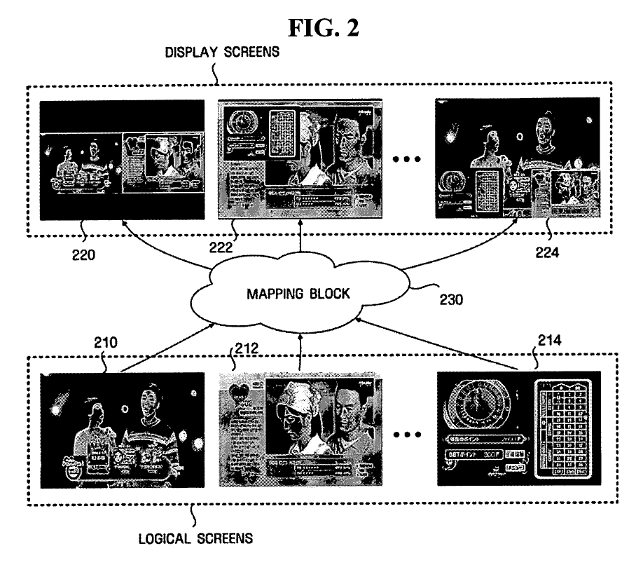

FIG. 2 is a diagram illustrating the relationship between a logical screen and a display screen according to an exemplary embodiment of the present invention.

Referring to FIG. 2, a service may be displayed using logical screens 210, 212, and 214. The logical screens 210, 212, and 214 are mapped to display screens 220, 222, and 224 through a mapping block 230.

In detail, the logical screens 210 and 212 are mapped to the display screen 220, the logical screens 212 and 214 are mapped to the display screen 222, and the logical screens 210, 212, and 214 are mapped to the display screen 224.

In short, at least one logical screen which displays a service is mapped to an arbitrary area of a display screen by the mapping block 230.

The mapping block 230 is a group of various pieces of information needed for mapping a logical screen to a display screen. Examples of the various pieces of information include coordinate information of a predetermined area on a display screen to which each of a plurality of logical screens is mapped, identification information of the logical screens and the display screen, and information specifying in what order the logical screens are displayed on the display screen.

The mapping block 230 may be realized by interfaces or functions prepared by various computer program languages to be executed and create or change the relationship between the logical screen and the display screen by using the above information as parameters.

Also, the mapping block 230 may be realized by a hardware which has a mapping function between a logical screen and a display screen.

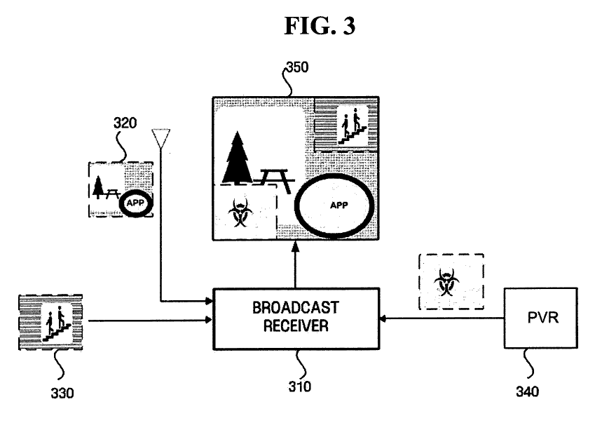

Further, services provided by various service sources may be displayed on a display screen, and the display screen may be displayed on a physical display device, as illustrated in FIG. 3.

There are service sources which provide broadcast services such as a terrestrial broadcaster 320 and a cable broadcaster 330, service sources which provide services stored in a storage medium such as a personal video recorder (PVR) 340, and service sources (not illustrated in FIG. 3) which provide services via a wired network or a wireless network.

A broadcast receiver 310 receives services from the service sources and produces logical screens displaying each of the received services.

Then, an arbitrary service is directly set on the display screen to be displayed on a physical display device using a predefined method or a method set by a user or an application. Otherwise, at least one logical screen that is mapped to an arbitrary area on the display screen is displayed on a physical display device 350. In short, services provided by the terrestrial broadcaster 320, the cable broadcaster 330, and the PVR are displayed on the physical display device 350.

The terrestrial broadcaster 320, the cable broadcaster 330, and the PVR 340 are illustrated in FIG. 3 as being service sources, but the present invention is not limited to it. Any type of multimedia content source which provides multimedia content items that can be displayed together can be a service source according to an exemplary embodiment of the present invention.

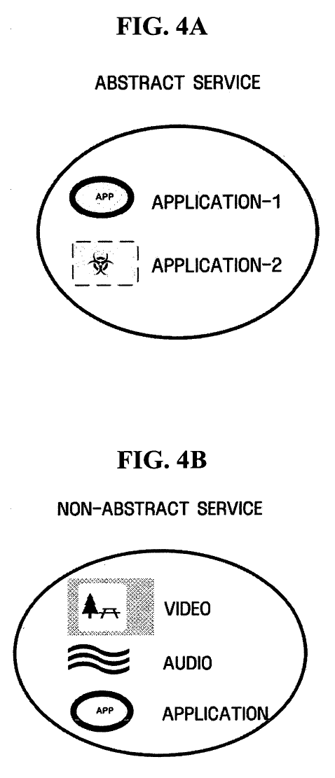

Services according to an exemplary embodiment of the present invention can be classified into abstract services and non-abstract services, as illustrated in FIGS. 4A and 4B.

The abstract services are not services provided by broadcast signals transmitted in real time but services independent of broadcast channels. The abstract services include only data components, i.e., application programs, without video components and audio components. Examples of the abstract services include services having unbound applications based on the standard.

The non-abstract services are understood as services other than abstract services.

According to the current exemplary embodiment of the present invention, both abstract services and non-abstract services have independency. For example, abstract services may be directly set on the physical display device not through logical screens and non-abstract services may be displayed on the logical screens. Then, the logical screens may be mapped to the display screen in which the abstract services are set. Thereafter, the display screen may be output through the physical display device. By doing so, the abstract services can be displayed on the display screen independently of the non-abstract services. In addition, the abstract services and non-abstract services may be mapped to different logical screens. Thereafter, the logical screens may be mapped to a single display screen. In other words, the abstract services can be displayed on the display screen independently of non-abstract services.

According to the current exemplary embodiment of the present invention, the logical screen and the display screen may be categorized as being different objects. Alternatively, a screen may serve as a logical screen or a display screen according to attribute information of one screen object.

In detail, whether a screen object is a logical screen or a display screen depends on the ‘type’ information among screen object attributes.

Further, the applications include an unbound application and a service bound application. Since the unbound application has a high priority, the resource is smoothly allocated. A monitor application corresponds to a specific unbound application that has the highest priority.

The service bound application is associated to a transport stream, and allows a lower priority than that of the unbound application. The service bound application does not function as a critical system. When a competition for resources occurs, the service bound application has a larger possibility of abandoning the resource allocation than the unbound application.

Application that is driven in an OCAP based terminal or a set-top box may include an electronic program guide (EPG), a video on demand (VOD), an application XYZ, a native application, and the like.

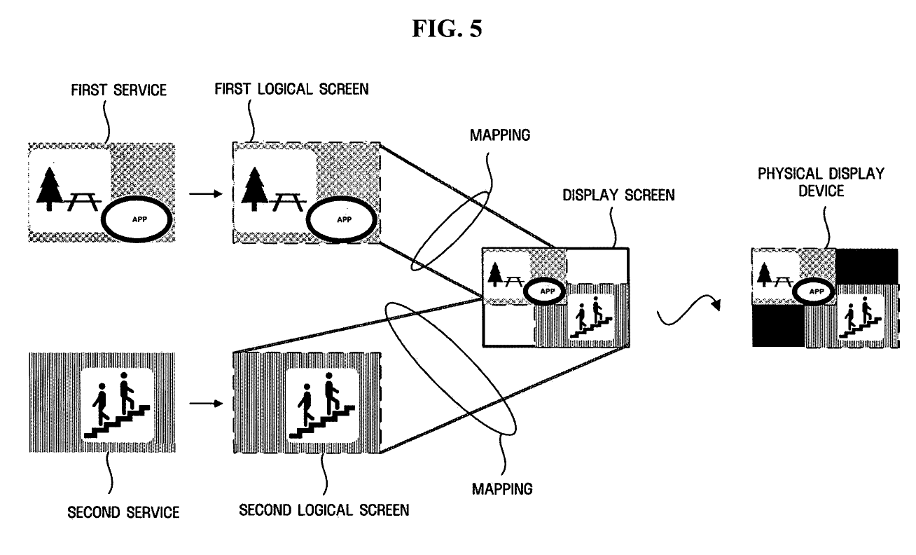

FIG. 5 is a diagram illustrating a process that two services are set on two logical screens to be mapped to a single display screen.

Referring to FIG. 5, a first service includes all the three service components, i.e., video, audio, and data components, and a second service includes only video and audio components. However, the present invention does not impose any restrictions on service components, and the first and second services illustrated in FIG. 5 are exemplary.

As illustrated in FIG. 5, the first and second services are displayed on a physical display device in almost the same manner as in the related art. According to the current exemplary embodiment of the present invention, it is possible to display a plurality of services on a physical display device independently of one another without imposing any restrictions on the number of services that can be displayed on a single display screen.

On the other hand, a data component includes application information regarding the application for the service, and the application information includes signal information indicating whether the application can be executed on the PiP screen. Examples of the application information include an application information table (AIT) based on the MHP standard and an eXtended application information table (XAIT) based on the OCAP standard. The signal information may be added to the application information.

According to the Digital Video Broadcasting (DVB) MHP standard, an application is subordinated to a service, and the lifecycle of the application is determined on the basis of a currently selected service. On the other hand, an application according to the OCAP standard is not subordinated to a service, and the lifecycle is further independent of the signal information.

Examples of the application include an application by host device manufacturer, an application that is signaled through an XAIT, and an application registered through a monitor application.

The OCAP terminal can manage the lifecycle of the bound or unbound application by receiving the signal. Various types of signaling for executing the service bound and unbound applications are supported on the basis of the OCAP standard. Content of an application database is created or renewed as a result of the signaling. The application database is a collective name of data that is managed by an application manager, and the application manager manages the lifecycle of the application using an application lifecycle API.

The application database includes information regarding an application currently being received and information regarding an unbound application.

An identifier is allocated to each application. If there are a plurality of applications with the same identifier, only one of the applications with a highest execution priority level may be included in the application database.

There are three types of application signaling, wherein one type is for service bound application and the other two types are for unbound application.

As described above, the signaling can be used to notify to the OCAP terminal whether the multiple screens are supported. In detail, a broadcaster provides an application to the OCAP terminal and notifies whether the currently provided application supports the multiple screens, by means of a signal. Therefore, the OCAP terminal can determine whether the currently provided application can be utilized, using the received signal. For example, it is possible to provide functions such as a screen size, screen position, pause, etc. to a user while providing the application on the logical screen.

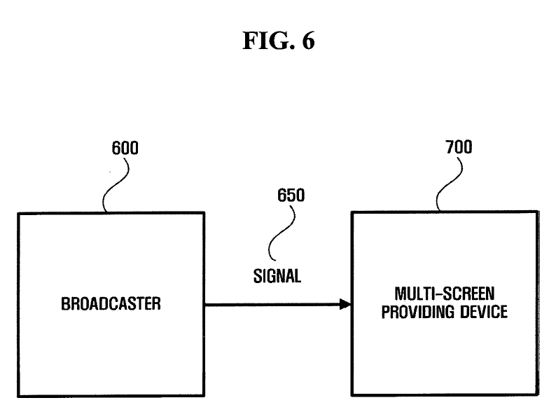

FIG. 6 is a diagram illustrating a configuration of a system providing multiple screens according to an exemplary embodiment of this invention. Referring to FIG. 6, a broadcaster 600 sends a signal to an OCAP terminal 700 (hereinafter, referred to as a multi-screen providing device).

The broadcaster 600 sends a signal 650 including a flag indicating whether the multiple screens are supported while sending an application to the apparatus 700. Therefore, the apparatus 700 allocates an additional logical screen for the supplied application and provides the functions such as a size, a position of the logical screen, pause, or the like.

The application can be signaled through an XAIT transferred through an MPEG stream. In this case, the XAIT includes necessary information for creating content of application data for the respective applications. For example, when receiving a new XAIT, the apparatus 700 can renew the application database using information signaled for the application associated to a service selected by a user.

In this case, the apparatus 700 varies the operations depending on the types of service, as follows:

a) when the application database does not have corresponding application in the application database, the apparatus 700 creates application information including information signaled by the XAIT;

b) even when the application data base has the corresponding application by the previous signaling, the signaling is no longer performed, the multi-screen providing device deletes the application from the application database;

c) when an application having the same version as in the application database is signaled, the apparatus 700 renew the application database on the basis of signaled application information;

d) when the application database includes an application, and a new application that is not related to active application instance is signaled, the apparatus 700 renews the application database on the basis of currently signaled application information; and

e) when the application database includes an application, and a new application that is related to active application instance is signaled, the apparatus 700 completes a signaling process for the previous application or creates application instance that permits only an application that is being executed.

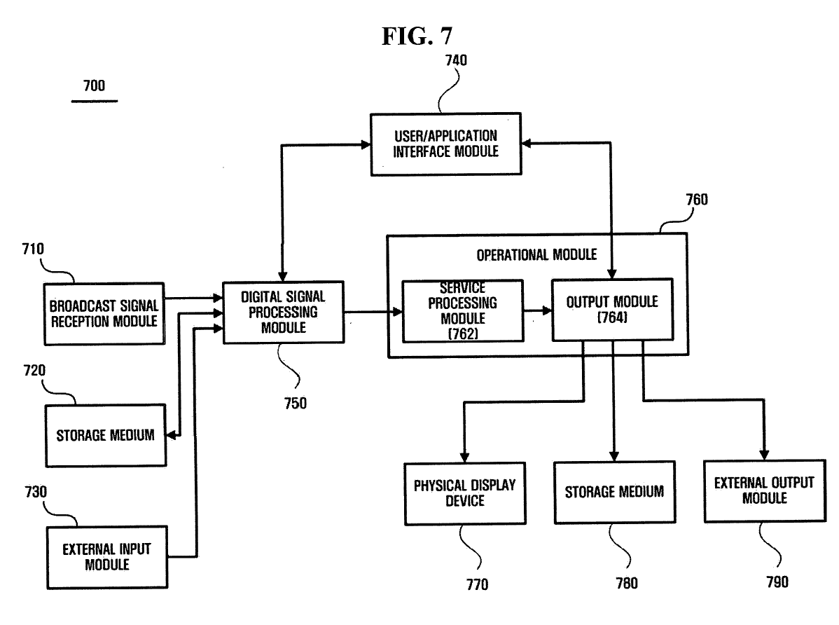

FIG. 7 is a block diagram of an apparatus for providing multiple screens according to an exemplary embodiment of the present invention.

Referring to FIG. 7, an apparatus 700 for providing multiple screens includes a digital signal processing module 750, a service processing module 762, an output module 764, and a user/application interface module 740.

Also, the apparatus 700 includes a broadcast signal reception module 710, a storage medium 720, and an external input module 730 as service sources, and includes a physical display device 770, a storage medium 780, and an external output module 790 as service output media.

The term ‘module’, as used herein, means, but is not limited to, a software or hardware component, such as a Field Programmable Gate Array (FPGA) or an Application Specific Integrated Circuit (ASIC), which performs certain tasks. A module may advantageously be configured to reside on the addressable storage medium and configured to be executed on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

The digital signal processing module 750 receives various information of a service such as a multimedia content item, e.g., video information, audio information, or data information, from the broadcast signal reception module 710, the storage medium 720, or the external input module 730.

The broadcast signal reception module 710 receives a satellite, terrestrial, or cable broadcast signal and transmits the received broadcast signal, the storage medium 720 stores video information, audio information, or data information of a service, and the external input module 730 receives video information, audio information, or data information of a service from an external device such as a network interface module connected to a network.

The digital signal processing module 750 restores a plurality of services using received service components. The restored services include abstract or non-abstract services.

Here, the phrase ‘a plurality of services’ refers to two or more services transmitted by the broadcast signal reception module 710 or two or more services respectively transmitted by the broadcast signal reception module 710 and the storage medium 720.

The digital signal processing module 750 may restore services according to selection by a user or an application with the aid of the user/application interface module 740. In this case, the user or the application may select the connection between an arbitrary service and a screen.

Further, the digital signal processing module 750 confirms whether the application included in data information can be executed on a screen with respect to the received data information. In this case, the digital signal processing module 750 confirms a predetermined flag of the signal included in the data information and then confirms whether the execution is supported. The result is transmitted to an operational module 760 and the user/application interface module 740.

For example, when the flag is 1, a first control signal indicating that the execution on the screen is supported is transmitted. Otherwise, when the flag is 0, a second control signal indicating that the execution of the screen is not supported is transmitted.

The digital signal processing module 750 may determine whether the application included in the received data information supports a plurality of logical screens for representing a plurality of services by referencing the flag of the signal included in the received data information. Accordingly, application information regarding an application currently being executed may be included in an application database and stored in the storage medium 720. The digital signal processing module 750 may generate or update an application database based on information present in the signal included in the received data information.

That is, application information regarding an application corresponding to a service selected by the user, for example, the number of logical screens, the type of the service, and the lifecycle of the application, may be updated. When a service ends, application information corresponding to the service is deleted from an application database.

The operational module 760 to which control signals have been transmitted varies the operations on the basis of the type of the control signal. When the first control signal is transmitted thereto, the operational module 760 operates the application on the screen. When the second control signal is transmitted thereto, the operational module 760 does not operate the application on the screen. In this case, the screen includes a PiP screen and a Picture-outside-Picture (PoP) screen.

The operational module 760 may map the logical screen to the display screen after operating the application on the logical screen, or directly operate the application on the display screen. For this purpose, the operational module 760 may include a service processing module 762 and an output module 764.

The service processing module 762 produces a logical screen and a display screen to display a service restored by the digital signal processing module 750. In this case, the logical screen may be a screen that is allocated for an application performed on a screen by being supported by signaling.

A received signal may include a setting flag and an ending flag, and the setting flag and the ending flag both indicate whether to terminate an application. More specifically, the setting flag indicates whether to terminate an application according to whether multiple screen settings have been modified or whether a service context has been shifted between logical screens. The ending flag indicates whether to terminate an application when the setting flag is not set. That is, the operational module 760 may terminate or suspend the operation of an application according to the values to which the setting flag and the ending flag are respectively set.

The setting flag may be classified into a mapping zone flag or a basic device setting flag. The mapping zone flag indicates whether to terminate an application according to whether a logical screen on which a basic graphic portion of an application is executed is completely mapped to an entire display screen. The basic device setting flag indicates whether to terminate an application according to the size, resolution, or screen ratio of a logical screen or according to whether available resources have been changed.

The ending flag is comprised of one-bit data. If the ending flag is set to a value of 1, the operational module 760 may terminate an application. On the other hand, if the ending flag is set to a value of 0, the operational module 760 may enable an application to continuously operate, instead of terminating the application.

The mapping zone flag is comprised of one-bit data. If the mapping zone flag is set to a value of 0, the operational module 760 may decide whether to terminate an application according to the value of the ending flag. If the mapping zone flag is set to a value of 1, the operational module 760 may enable an application to continuously operate, instead of terminating the application.

The suspension of the operation of an application with reference to the setting flag and the ending flag fails sometimes. In this case, the operational module 760 may be able to terminate the operation of the application.

An application whose operation has been suspended may resume its operation. If an application cannot resume its operation, the operational module 760 may terminate the operation of the application.

If an application whose operation has been suspended has an input focus, the operational module 760 may remove the input focus from the application. In this case, the operational module 760 may not readily notify the application of the removal of the input focus from the application. Instead, the operational module 760 may notify the application of the removal of the input focus from the application when the application resumes its operation.

If an application whose operation has been suspended uses external resources, the operational module 760 may suspend the application from using the external resources any longer. In this case, the operational module 760 may not readily notify the application that the application has been suspended from using the external resources any longer. Instead, the operational module 760 may notify the application that the application has been suspended from using the external resources any longer, when the application resumes its operation.

The output module 764 maps a plurality of logical screens produced by the service processing module 762 to the display screen. The mapping of the logical screens to the display screen may be conducted using a predefined method or a method set by the user with the aid of the user/application interface module 762. In detail, the user can perform of mapping for an application that supports multiple screens, in addition to video or audio.

A service restored by the digital signal processing module 750 may not be connected to a logical screen produced by the service processing module 762, but directly connected to a display screen to be output by the output module 764.

A display screen provided by the output module 764 may be displayed on the physical display device 970 or may be stored in the storage medium 780. Examples of the storage medium 780 include computer readable floppy discs, hard discs, CD-ROM. DVD, DVD-ROM, BD (Blu-ray Disc), and semiconductor memories.

Also, a display screen provided by the output module 764 may be transmitted to an external device connected to a network via the external output module 790.

For this, the output module 764 may include a plurality of output ports via which a display screen can be provided. In this case, a display screen can be provided via an output port set in advance as a default or an output port chosen by the user with the aid of the user/application interface module 740.

The user or the application can choose one of a plurality of services or restore desired services using the user/application interface module 740. Also, the user can choose one of a plurality of display screens using the user/application interface module 740.

Since the modules illustrated in FIG. 7 are divided according to their functions, it is possible to be connected to the other modules.

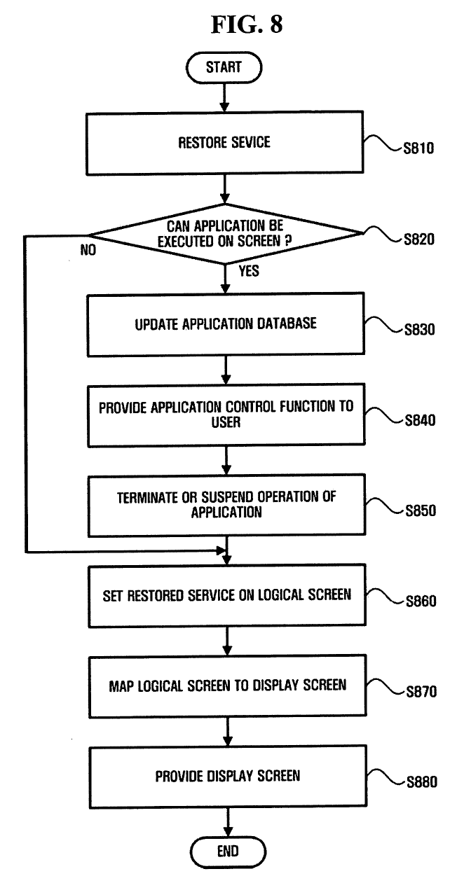

FIG. 8 is a flowchart illustrating a method of dynamically configuring multiple screens according to an exemplary embodiment of the present invention.

In general, video information, audio information, and data information constituting a multimedia content item are transmitted in a predetermined format, for example, an MPEG stream format. In operation S810, an apparatus for providing a service such as a multimedia content service receives video information, audio information, and data information and restores a service based on the video information, the audio information, and the data information. Here, the service restored in operation S810 may be selected or previously determined by a user or an application. The user may use a menu displayed on the physical display device 770 or a remote controller to select the connections between an arbitrary screen and a screen. The application may select the connections using an API.

In operation S820, the apparatus 700 determines whether the application included in the data information can be executed on the screen on the basis of the received data information while receiving the multimedia content items.

The apparatus 700 may determine whether the application included in the data information supports a plurality of logical screens for representing a plurality of services by referencing a signal included in the data information.

If it is determined in operation S820 that the application included in the data information cannot be executed on the screen, the method proceeds to operation S860. Alternatively, if it is determined in operation S820 that the application included in the data information can be executed on the screen, the apparatus 700 updates an application database by adding information regarding the application included in the data information to the application database in operation S830.

The result of the determination performed in operation S820 is output through the user/application interface module 740. In operation S840, when a signal included in the data information includes a flag that the multiple screens are supported, the user/application interface module 740 provides a control function for the application (for example, allocation of the logical screen and control of the screen size) to a user.

Further, the apparatus 700 manages the lifecycle of the application using a signal 650 that is continuously received. When the signal is not received, the apparatus 700 terminates the application.

The signal 650 may include a setting flag which indicate whether to terminate the application according to whether multiple screen settings have been modified or according to whether a service context has been shifted between logical screens; and an ending flag which indicates whether to terminate the application when the setting flag is not set. In operation S850, the apparatus 700 terminates or suspends an operation of the application according to the values to which the setting flag and the ending flag are respectively set.

The apparatus 700 may terminate an operation of an application that cannot be suspended. Alternatively, the apparatus 700 may terminate an operation of an application whose operation has been suspended if the application cannot resume its operation. If the application whose operation has been suspended includes input focus or if external resources are allocated to the application whose operation has been suspended, the apparatus 700 may remove the input focus from the application whose operation has been suspended or may stop using the external resources any longer.

In operation S860, the apparatus 700 sets the restored service to be displayed on the logical screen according to the exemplary embodiment after confirming the signaling. Further, in operation S870, the logical screen is mapped to a display screen according to the exemplary embodiment. In this case, the user can allocate the supplied application to a logical screen and input the size and position of the screen. Therefore, the apparatus 700 can map the logical screen to the display screen according to the input content by the user.

In operation S880, the apparatus 700 provides the display screen via the physical display device 770, the storage medium 780, or a network.

The restored service is illustrated in FIG. 8 as being displayed on a physical display device via a logical screen. However, the restored service may be directly displayed on a physical display device without passing through the logical screen.

When the user selects the PiP service, the PiP service is realized in two modes. In the first mode, only video component for PiP service selected on the main screen is provided without creating a separate logical screen for PiP service, that is, PiP screen. In the second mode, a separate logical screen for PiP service is created to provide the PiP service selected on the created PiP screen.

FIG. 8 illustrates a method of mapping only one service to a display screen for simplicity. However, a plurality of services may be mapped to a display screen with or without passing through a plurality of logical screens.

When the physical display device 770 is provided to the user in this manner, the user can perform a plurality of services.

According to the apparatus for providing multiple screens and a method of dynamically configuring the multiple screens of exemplary embodiments of the present invention, a user can control a screen that is allocated to a content item including an application by providing a packet including predetermined information in order to dynamically configure multiple screens that provides a plurality of content items on a physical display device.

While the present invention has been particularly illustrated and described with reference to exemplary embodiments thereof, it will be understood by those of ordinary skill in the art that various changes in form and details may be made therein without departing from the spirit and scope of the present invention as defined by the following claims. Therefore, it is to be understood that the above-described exemplary embodiments have been provided only in a descriptive sense and will not be construed as placing any limitation on the scope of the invention.

What is claimed is:

1. An apparatus for providing multiple screens, the apparatus comprising:
a digital signal processing module which determines whether an application included in received data information supports a plurality of logical screens for representing a plurality of services based on a signal included in the received data information; and
an operational module which maps the plurality of logical screens to a display screen according to a result of the determination performed by the digital signal processing module.

2. The apparatus of claim 1, wherein the digital signal processing module generates or updates an application database comprising application information regarding the application.

3. The apparatus of claim 2, wherein the application information comprises at least one of a number of the logical screens, a type of a service, and a lifecycle of the application.

4. The apparatus of claim 1, wherein the signal comprises:
a setting flag which indicates whether to terminate the application according to one of whether multiple screen settings have been changed and whether a service context has been shifted between the plurality of logical screens; and
an ending flag which indicates whether to terminate the application if the setting flag is not set.

5. The apparatus of claim 4, wherein the setting flag comprises:
a mapping zone flag which indicates whether to terminate the application according to whether a logical screen on which a basic graphic portion of the application operates is completely mapped to the entire display screen; and
a basic device setting flag which indicates whether to terminate the application according to a size, a resolution, or a screen ratio of the logical screen on which the basic graphic portion of the application operates or according to whether available resources have been changed.

6. The apparatus of claim 4, wherein the operational module terminates or suspends the application according to values to which the setting flag and the ending flag are respectively set.

7. The apparatus of claim 6, wherein, if an operation the application cannot be suspended, the operational module terminates the operation of the application.

8. The apparatus of claim 6, wherein, if an application whose operation has been suspended cannot resume operation, the operational module terminates the application whose operation has been suspended.

9. The apparatus of claim 6, wherein, if an application whose operation has been suspended includes input focus, the operational module removes the input focus from the application whose operation has been suspended.

10. The apparatus of claim 9, wherein, if the application whose operation has been suspended resumes operation, the operational module notifies the application whose operation has been resumed that the input focus has been removed from the application whose operation has been suspended.

11. The apparatus of claim 9, wherein, if the application whose operation has been suspended uses external resources, the operational module stops the application whose operation has been suspended from using the external resources any longer.

12. The apparatus of claim 11, wherein, if the application whose operation has been suspended resumes operation, the operational module notifies the application whose operation has been resumed that the application whose operation has been suspended has been stopped from using the external resources any longer.

13. A method of dynamically configuring multiple screens, the method comprising:
determining whether an application included in received data information supports a plurality of logical screens for representing a plurality of services based on a signal included in the received data information; and
mapping the plurality of logical screens to a display screen according to a result of the determining.

14. The method of claim 13, further comprising generating or updating an application database comprising application information regarding the application.

15. The method of claim 14, wherein the application information comprises at least one of a number of the logical screens, a type of a service, and a lifecycle of the application.

16. The method of claim 13, wherein the signal comprises:
a setting flag which indicates whether to terminate the application according to one of whether multiple screen settings have been changed and whether a service context has been shifted between the plurality of logical screens; and
an ending flag which indicates whether to terminate the application if the setting flag is not set.

17. The method of claim 16, wherein the setting flag comprises:
a mapping zone flag which indicates whether to terminate the application according to whether a logical screen on which a basic graphic portion of the application operates is completely mapped to the entire display screen; and
a basic device setting flag which indicates whether to terminate the application according to a size, a resolution, or a screen ratio of the logical screen on which the basic graphic portion of the application operates or according to whether available resources have been changed.

18. The method of claim 16, further comprising terminating or suspending the application according to values to which the setting flag and the ending flag are respectively set.

19. The method of claim 18, wherein, if an operation of the application cannot be suspended, the terminating or the suspending comprises terminating the operation of the application.

20. The method of claim 18, wherein, if an application whose operation has been suspended cannot resume operation, the terminating or the suspending comprises terminating the application whose operation has been suspended.

21. The method of claim 18, wherein, if an application whose operation has been suspended includes input focus, the terminating or the suspending comprises removing the input focus from the application whose operation has been suspended.

22. The method of claim 21, further comprising, if the application whose operation has been suspended resumes operation, notifying the application whose operation has been resumed that the input focus has been removed from the application whose operation has been suspended.

23. The method of claim 18, further comprising, if the application whose operation has been suspended uses external resources, stopping the application whose operation has been suspended from using the external resources any longer.

24. The method of claim 23, further comprising, if the application whose operation has been suspended resumes operation, notifying the application whose operation has been resumed that the application whose operation has been suspended has been stopped from using the external resources any longer.
